(19) United States
(12) Patent Application Publication
(10) Pub. No.: US 2010/0185737 A1
(43) Pub. Date: Jul. 22, 2010

(54) METHOD OF SENDING ELECTRONIC GREETING CARD FROM DIGITAL PHOTO FRAME

(75) Inventors: YI-FANG WU, Tu-Cheng (TW); JIE YUAN, Shenzhen City (CN); YONG-HUI XIAO, Shenzhen City (CN)

Correspondence Address: PCE INDUSTRY, INC.;ATT. Steven Reiss, 288 SOUTH MAYO AVENUE, CITY OF INDUSTRY, CA, 91789, US

(73) Assignees: HONG FU JIN PRECISION INDUSTRY (ShenZhen) CO., LTD ., Shenzhen City (CN); HON HAI PRECISION INDUSTRY CO., LTD., Tu-Cheng (TW)

(21) Appl. No.: 12/548,104

(22) Filed: Aug. 26, 2009

(30) Foreign Application Priority Data
Jan. 16, 2009 (CN) 200910300222.4

(51) Int. Cl. G06F 15/16

(52) U.S. Cl. 709/206

(57) ABSTRACT

A method of sending an electronic greeting card from a digital photo frame (DPF) is disclosed. The method includes selecting at least one stored electronic greeting phrase from a template module of the DPF to the electronic greeting card. The DPF sends the greeting card as an email to a mail server through Simple Mail Transfer Protocol (SMTP). The DPF stores the electronic greeting card in a mail box of the mail server according to the destination address. The electronic greeting card is received from the mail box through Post Office Protocol (POP).

### BACKGROUND

1. Technical Field

The present disclosure relates to a method of sending an electronic greeting card and, particularly, to a method of sending an electronic greeting card from a digital photo frame.

2. Description of Related Art

Digital photo frames (DPF) are becoming increasingly popular due to the convenience and ease of manipulation when browsing photos stored therein. However, the typical digital photo frame can only display photos.

### BRIEF DESCRIPTION OF THE DRAWINGS

Many aspects of the embodiments can be better understood with references to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is a system view of a method of sending an electronic greeting card from a digital photo frame.

FIG. 2 is a flow chart of a method of sending an electronic greeting card from a digital photo frame.

FIG. 3 is a schematic view of the electronic greeting card of a method of sending an electronic greeting card from a digital photo frame.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

In general, the word “module,” as used herein, refers to logic embodied in hardware or firmware, or to a collection of software instructions, written in a programming language, such as, for example, Java, C, or assembly. One or more software instructions in the modules may be embedded in firmware, such as an EPROM. It will be appreciated that modules may comprise connected logic units, such as gates and flip-flops, and may comprise programmable units, such as programmable gate arrays or processors. The modules described herein may be implemented as either software and/or hardware modules and may be stored in any type of computer-readable medium or other computer storage device.

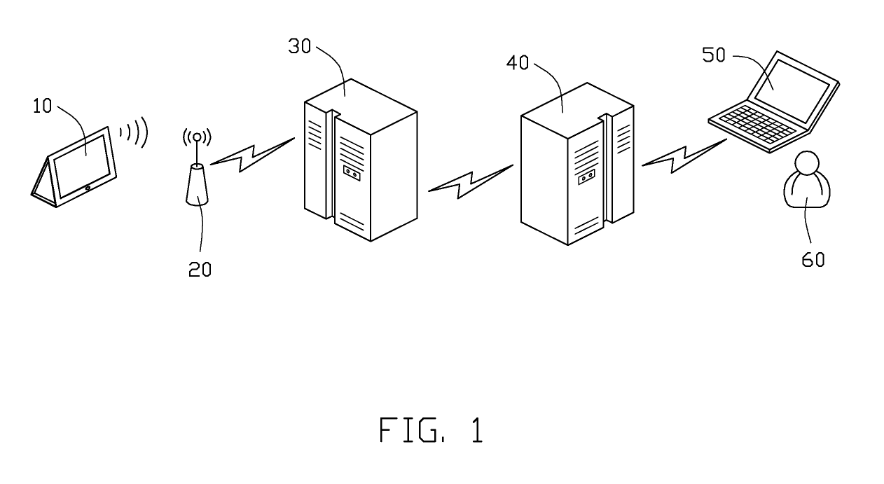

Referring to FIG. 1, a method of sending an electronic greeting card from a digital photo frame is disclosed. The electronic greeting cards can be sent as emails. The method includes a digital photo frame (DPF) 10, an access point 20, a Simple Mail Transfer Protocol (SMTP) server 30, a Post Office Protocol (POP) server 40, a computer 50, and a receiver 60.

The DPF 10 can support WiFi 802.11b standard. The DPF 10 connects to the SMTP server 30 through the access point 20. The SMTP server 30 connects with the POP server 40 over a TCP/IP connection. The computer 50 connects to the POP server 40. The receiver 60 accesses email through the computer 50.

The DPF 10 has a client mail application to send the email to the SMTP server 30 via the access point 20. The email includes a destination address. The POP server 40 stores the email in the mail box according to the destination address of the email. The POP server 40 informs the receiver 60 when a new email has arrived. The receiver 60 allows viewing the email through a client mail application of the computer 50. The DPF 10 first sends the email to the ISP server thereof, then to the SMTP server 40. The POP server 40 sends the email to the ISP server of the computer 50, then to the computer 50.

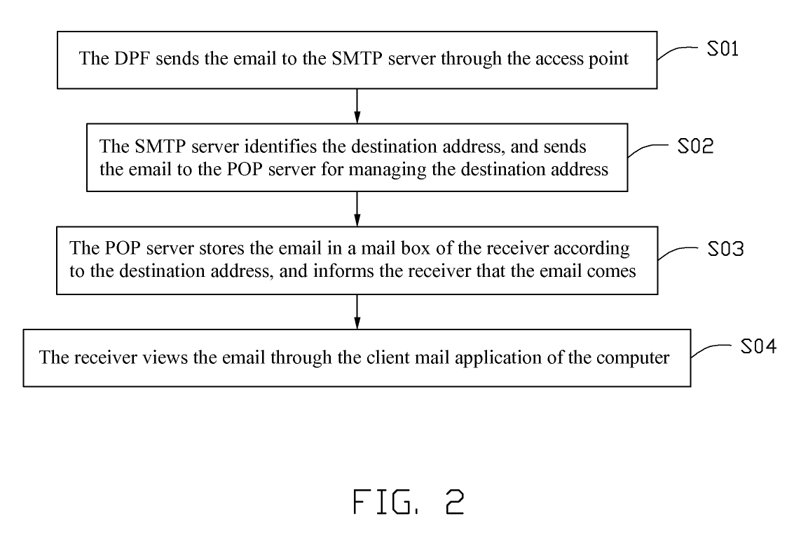

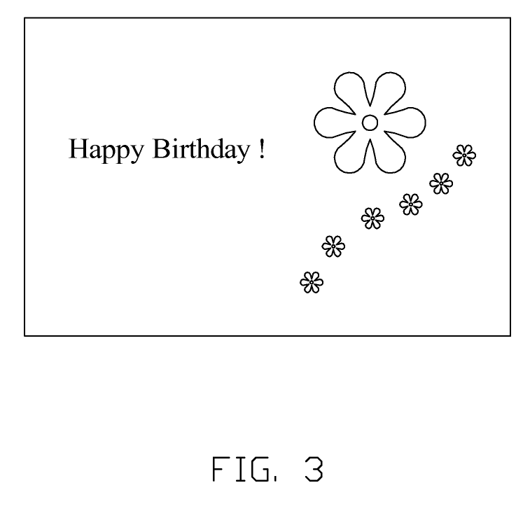

Referring to FIG. 2 and FIG. 3, a flow chart of a method of sending an electronic greeting card from a DPF is disclosed. The method includes the following steps:

S01: the DPF 10 sends the email to the SMTP server 30 through the access point 20, the email includes a destination address.

S02: the SMTP server 30 identifies the destination address, and sends the email to the POP server 40 for managing the destination address.

S03: the POP server 40 stores the email in a mailbox of the receiver 60 according to the destination address, and informs the receiver 60 that the email has arrived.

S04: the receiver 60 allows viewing the email through the client mail application of the computer 50.

In FIG. 3, the email sent by the DPF 10 may include photos stored in the DPF 10. A plurality of greeting phrases is stored in a template module of the DPF 10. The user selects at least one electronic greeting phrase from the template module of the DPF 10 to constitute an electronic greeting card as well as one or more photos if desired. The user adds a destination address to the electronic greeting card. Some words may be added on the email through soft keyboard in the DPF 10.

It is to be understood, however, that even though numerous characteristics and advantages of the disclosure have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

It is also to be understood that the above description and the claims drawn to a method may include some indication in reference to certain steps. However, the indication used is only to be viewed for identification purposes and not as a suggestion as to an order for the steps.

What is claimed is:

1. A method of sending an electronic greeting card from a digital photo frame (DPF), comprising:
selecting at least one electronic greeting phrase from a template module of the DPF, wherein a plurality of greeting phrases is stored in the template module;
adding a destination address to the greeting card;
sending the greeting card as an email to a mail server through Simple Mail Transfer Protocol (SMTP);
storing the electronic greeting card in a mailbox of the mail server according to the destination address; and
receiving the electronic greeting card from the mail box through Post Office Protocol (POP).

2. The method of claim 1, wherein a client mail application, in the DPF, sends the electronic greeting card to the mail server.

3. The method of claim 1, wherein the DPF sends the electronic greeting card to the mail server through an access point.

4. The method of claim 1, wherein the DPF sends the electronic greeting card to the mail server through an Internet service provider (ISP) server.

5. The method of claim 1, wherein the DPF supports IEEE 802.11 standard.

6. The method of claim 1, wherein a photo is part of the electronic greeting card.

7. The method of claim 1, wherein the template module is capable of being configured through an input device.

8. The method of claim 7, wherein the input device is a remote control.

9. A method of sending an electronic greeting card from a digital photo frame (DPF), comprising:
selecting at least one electronic greeting phrase from a template module of the DPF, wherein a plurality of greeting phrases is stored in the template module;
adding a destination address to the greeting card;
sending the greeting card as an email to a Simple Mail Transfer Protocol (SMTP) server;
relaying the email to a Post Office Protocol (POP) server capable of managing email addresses;
storing the email in a mailbox according to the destination address;
accessing the mailbox to view the email.

10. The method of claim 9, wherein a client mail application, in the DPF, sends the electronic greeting card to the mail server.

11. The method of claim 9, wherein the DPF sends the electronic greeting card to the mail server through an access point.

12. The method of claim 9, wherein the DPF sends the electronic greeting card to the mail server through an Internet service provider (ISP) server.

13. The method of claim 9, wherein the DPF supports IEEE 802.11 standard.

14. The method of claim 9, wherein a photo is part of the electronic greeting card.

15. The method of claim 9, wherein the template module is capable of being configured through an input device.

16. The method of claim 15, wherein the input device is a remote control.
